(19) United States
(12) Patent Application Publication
(10) Pub. No.: US 2026/0356129 A1
(43) Pub. Date: Nov. 12, 2026

(54) TIRE

(71) Applicant: THE YOKOHAMA RUBBER CO., LTD., Kanagawa (JP)

(72) Inventor: Masamitsu MATSUMOTO, Kanagawa (JP)

(21) Appl. No.: 19/137,169

(22) PCT Filed: Dec. 7, 2023
(86) PCT No.: PCT/JP2023/043851

§ 371 Date: Jun. 9, 2025

(30) Foreign Application Priority Data
Dec. 14, 2022 (JP) 2022-199576

(51) Int. Cl. B60C 11/03; B60C 11/12

(52) U.S. Cl. CPC B60C 11/0304; B60C 11/0306; B60C 11/1218; B60C 11/1236; B60C 2011/0341

(57) ABSTRACT

A tire includes first, second, third and fourth main grooves formed such that a groove width on a vehicle outermost side is smaller than a groove width on a vehicle innermost side; first, second, third, fourth and fifth land portions provided from the vehicle inner side to the vehicle outer side; a narrow groove in the fifth land portion; first sipes each having one end connected to but not extending over the first main groove; second, third and fourth sipes; fifth sipes each having one end connected to but not extending over the narrow groove; and fifth lug grooves. The number of the second sipes is twice or more of the number of the third and fourth sipes. The first, second, third, fourth and fifth sipes and the fifth lug groove are inclined in the same direction with respect to the tire width direction.

### TECHNICAL FIELD

The technology relates to a tire.

### BACKGROUND ART

For example, International Patent Publication No. WO 2018/151108 describes a pneumatic tire that can provide improved wet steering stability performance while ensuring vehicle external noise performance.

In order to improve noise performance (NV: noise vibration), it is effective to reduce a groove width and a groove volume of a tread surface. However, if the groove width and the groove volume are reduced, drainage properties cannot be ensured, and wet grip performance deteriorates.

### SUMMARY

The technology provides a tire that can provide excellent noise performance and wet grip performance.

A tire according to one aspect of the present technology is a tire including, in a tread surface, a tread pattern that is asymmetric with respect to a tire equatorial plane as a boundary and has an orientation designated with respect to a vehicle width direction when mounted on a vehicle, the tread pattern including: four main grooves of a first main groove, a second main groove, a third main groove, and a fourth main groove extending in a tire circumferential direction, provided in a tire width direction from an inner side in the vehicle width direction to an outer side in the vehicle width direction, and formed such that at least a groove width on an outermost side in the vehicle width direction is smaller than a groove width on an innermost side in the vehicle width direction; five land portions of a first land portion, a second land portion, a third land portion, a fourth land portion, and a fifth land portion defined by each of the main grooves, extending in a rib shape in the tire circumferential direction, and provided in the tire width direction from the inner side in the vehicle width direction to the outer side in the vehicle width direction; at least one narrow groove extending in the tire circumferential direction and provided in the tire width direction in the fifth land portion, the narrow groove having a groove width smaller than a groove width of the fourth main groove; a plurality of first sipes provided in the tire circumferential direction in the first land portion, the first sipes each having one end that is connected to but does not extend over the first main groove and the other end extending to the outer side in the tire width direction, the first sipes being provided only in the first land portion; a plurality of second sipes extending in the tire width direction and provided in the tire circumferential direction in the second land portion; a plurality of third sipes extending in the tire width direction and provided in the tire circumferential direction in the third land portion; a plurality of fourth sipes extending in the tire width direction and provided in the tire circumferential direction in the fourth land portion; a plurality of fifth sipes provided in the tire circumferential direction in the fifth land portion, the fifth sipes each having one end that is connected to but does not extend over the narrow groove and the other end extending to the outer side in the tire width direction, the fifth sipes being provided only on an outer side in the tire width direction of the narrow groove; and a plurality of fifth lug grooves provided in the tire circumferential direction in the fifth land portion, the fifth lug grooves each having one end connected to the fourth main groove and the other end that extends to the outer side in the tire width direction, is not connected to the narrow groove, and terminates; in which the number of the second sipes is twice or more of the number of the third sipes and the number of the fourth sipes, the sipes and grooves provided in the second land portion, the third land portion, and the fourth land portion is provided to be inclined in the same direction with respect to the tire width direction, and the first sipes, the fifth sipes, and the fifth lug grooves have an inclination in the same direction as the sipes and the grooves provided in the second land portion, the third land portion, and the fourth land portion.

According to the technology, noise performance and wet grip performance can be improved.

### BRIEF DESCRIPTION OF DRAWINGS

FIG. 1 is a meridian cross-sectional view of a pneumatic tire according to an embodiment.

FIG. 2 is a plan view of a tread surface of the pneumatic tire according to an embodiment.

FIG. 3 is a partially enlarged plan view of the tread surface of the pneumatic tire according to an embodiment.

FIG. 4 is a partially enlarged plan view of the tread surface of the pneumatic tire according to an embodiment.

FIG. 5 is a schematic perspective view of a sipe of the pneumatic tire according to an embodiment.

FIG. 6 is a schematic perspective view of another example of the sipe of the pneumatic tire according to an embodiment.

FIGS. 7A-7C include a table showing the results of performance tests of pneumatic tires according to embodiments.

FIGS. 8A-8C include a table showing the results of performance tests of pneumatic tires according to embodiments.

### DETAILED DESCRIPTION

Pneumatic tires according to embodiments of the present technology are described in detail below with reference to the drawings. However, the technology is not limited to the embodiments. Constituents of the embodiments include elements that are substitutable while maintaining consistency with the technology, and obviously substitutable elements. The plurality of modified examples described in the embodiments can be combined as desired within the scope apparent to one skilled in the art.

In the following description, the term “tire radial direction” refers to a direction orthogonal to the tire rotation axis (not illustrated) which is a rotation axis of a pneumatic tire 1, the term “inner side in the tire radial direction” refers to a side toward the tire rotation axis in the tire radial direction, and the term “outer side in the tire radial direction” refers to a side away from the tire rotation axis in the tire radial direction. The term “tire circumferential direction” refers to a circumferential direction with the tire rotation axis as a center axis. The term “tire width direction” refers to a direction parallel with the tire rotation axis, the term “inner side in the tire width direction” refers to a side toward a tire equatorial plane (tire equator line) CL in the tire width direction, and the term “outer side in the tire width direction” refers to a side away from the tire equatorial plane CL in the tire width direction. The term “tire equatorial plane CL” refers to a plane that is orthogonal to the tire rotation axis and that runs through the center of the tire width of the pneumatic tire 1. The tire equatorial plane CL aligns, in a position in the tire width direction, with a center line in the tire width direction corresponding to a center position of the pneumatic tire 1 in the tire width direction. The tire width is the width in the tire width direction between portions located on the outermost sides in the tire width direction, or in other words, the distance between the portions that are the most distant from the tire equatorial plane CL in the tire width direction. The term “tire equator line” refers to a line in the tire circumferential direction of the pneumatic tire 1 that lies on the tire equatorial plane CL. The term “cross-section in the tire meridian direction (meridian cross-sectional view)” refers to a cross section of the tire taken along a plane that includes the tire rotation axis.

Furthermore, the inner side in the vehicle width direction and the outer side in the vehicle width direction are defined with respect to the vehicle width direction (tire width direction) when the tire is mounted on the vehicle. Further, the pneumatic tire 1 includes a mounting direction indicator portion (not illustrated) that indicates a tire mounting direction with respect to the vehicle. Examples of the mounting direction indicator portion include a mark and a recess/protrusion on a sidewall portion of the tire. For example, Regulation No. 30 of the Economic Commission for Europe Regulation (ECE R30) mandates that a vehicle mounting direction indicator portion be provided on the sidewall portion on the outer side in the vehicle width direction in a case where the tire is mounted on a vehicle. When the pneumatic tire 1 of the present embodiment is mounted on the vehicle, the orientation with respect to the vehicle width direction is designated.

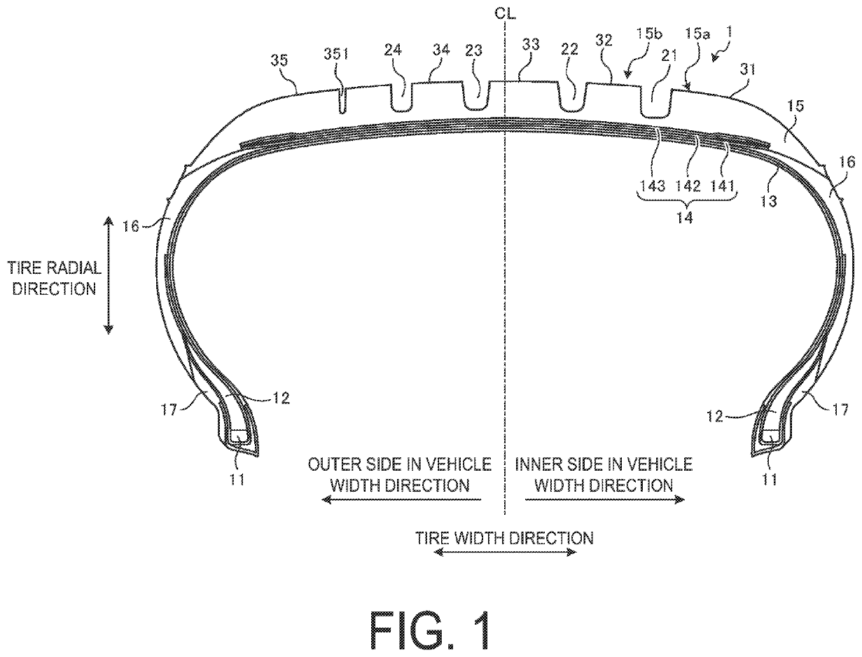

As illustrated in FIG. 1, the pneumatic tire 1 of the embodiment has an annular structure with the tire rotation axis as its center and includes a pair of bead cores 11, 11, a pair of bead fillers 12, 12, a carcass layer 13, a belt layer 14, a tread rubber 15, a pair of sidewall rubbers 16, 16, and a pair of rim cushion rubbers 17, 17.

The pair of bead cores 11, 11 have an annular structure formed by winding a bead wire made of steel or an organic fiber material multiple times in the tire circumferential direction, and constitute cores of the left and right bead portions.

The pair of bead fillers 12, 12 are disposed on an outer circumference of the pair of bead cores 11, 11 in the tire radial direction and constitute the bead portions.

The carcass layer 13 has a single layer structure including one carcass ply or a multilayer structure including a plurality of carcass plies layered, extends in a toroidal shape between the left and right bead cores 11, 11, and constitutes the backbone of the tire. Both end portions of the carcass layer 13 are turned back toward outer sides in the tire width direction and fixed to wrap the bead cores 11 and the bead fillers 12. The carcass ply (plies) of the carcass layer 13 is made by performing a rolling process on a plurality of coating rubber-covered carcass cords made of steel or an organic fiber material (e.g., aramid, nylon, polyester, or rayon). The carcass ply (plies) has a carcass angle (defined as the inclination angle in the longitudinal direction of the carcass cords with respect to the tire circumferential direction), as an absolute value, of 80 degrees or more and 95 degrees or less.

The belt layer 14 is a multilayer structure including a pair of cross belts 141, 142 and a belt cover 143 and is disposed around the outer circumference of the carcass layer 13. The pair of cross belts 141, 142 is made by performing a rolling process on a plurality of coating rubber-covered belt cords made of steel or an organic fiber material. The cross belts 141, 142 have a belt angle, as an absolute value, of 20 degrees or more and 55 degrees or less. Furthermore, the pair of cross belts 141, 142 have belt angles (defined as the inclination angle in the longitudinal direction of the belt cords with respect to the tire circumferential direction) of mutually opposite signs and are layered so that the longitudinal directions of the belt cords intersect each other (a so-called cross-ply structure). The belt cover 143 is made by covering belt cords made of steel or an organic fiber material with a coating rubber. The belt cover 143 has a belt angle, as an absolute value, of 0 degrees or more and 10 degrees or less. Further, the belt cover 143 is, for example, a strip material formed by covering one or more belt cords with a coating rubber and winding the strip material spirally around the outer circumferential surface of the cross belts 141, 142 multiple times in the tire circumferential direction.

The tread rubber 15 is disposed in the outer circumferences in the tire radial direction of the carcass layer 13 and the belt layer 14 and constitutes a tread portion of the tire. Further, in the tread portion, the tread rubber 15 constitutes a tread surface 15a on an outer circumferential surface that comes into contact with a road surface during traveling.

The pair of sidewall rubbers 16, 16 are respectively disposed on an outer side of the carcass layer 13 in the tire width direction to constitute left and right sidewall portions.

The pair of rim cushion rubbers 17, 17 are disposed on an inner side of both the bead cores 11, 11 and the turned back portions of the carcass layer 13 in the tire radial direction. The pair of rim cushion rubbers 17, 17 constitute the contact surfaces of the left and right bead portions with respect to the rim flanges.

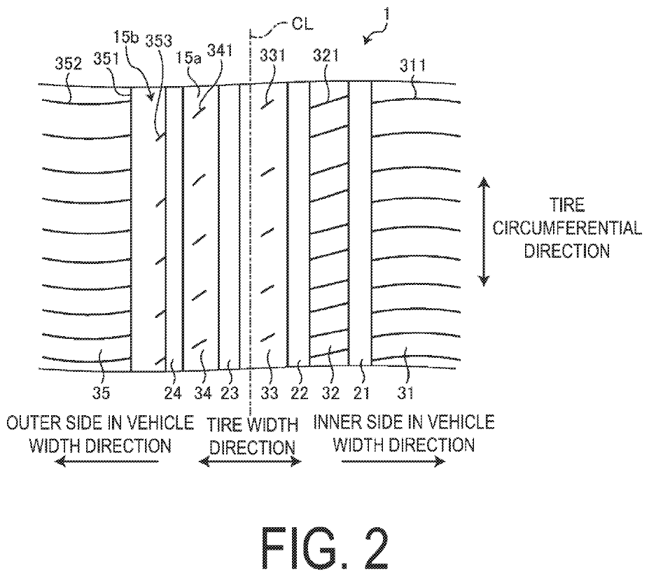

Further, as illustrated in FIGS. 1 and 2, the pneumatic tire 1 of the embodiment includes a tread pattern 15b on the tread surface 15a. In the pneumatic tire 1 of the embodiment, the tread pattern 15b for an all-season tire is illustrated. In the pneumatic tire 1 of the embodiment, the tread pattern 15b that is asymmetric in the tire width direction with respect to the tire equatorial plane CL is illustrated.

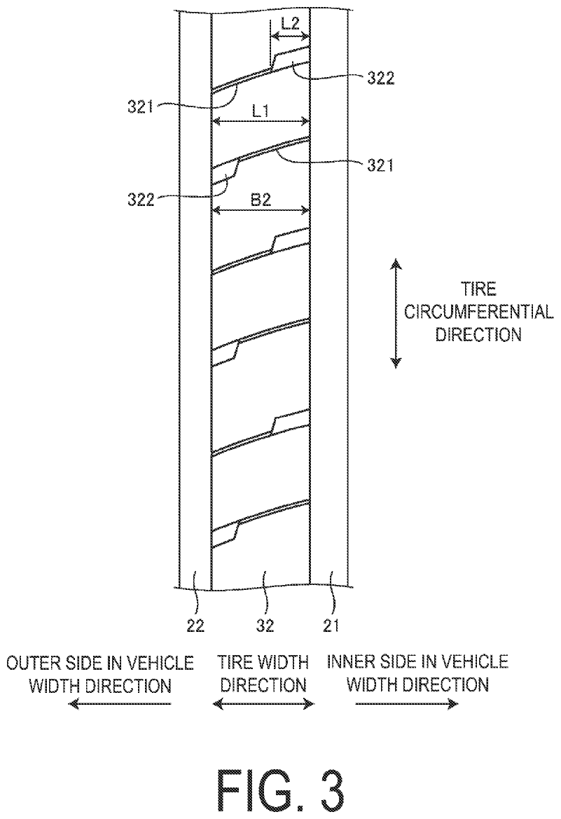

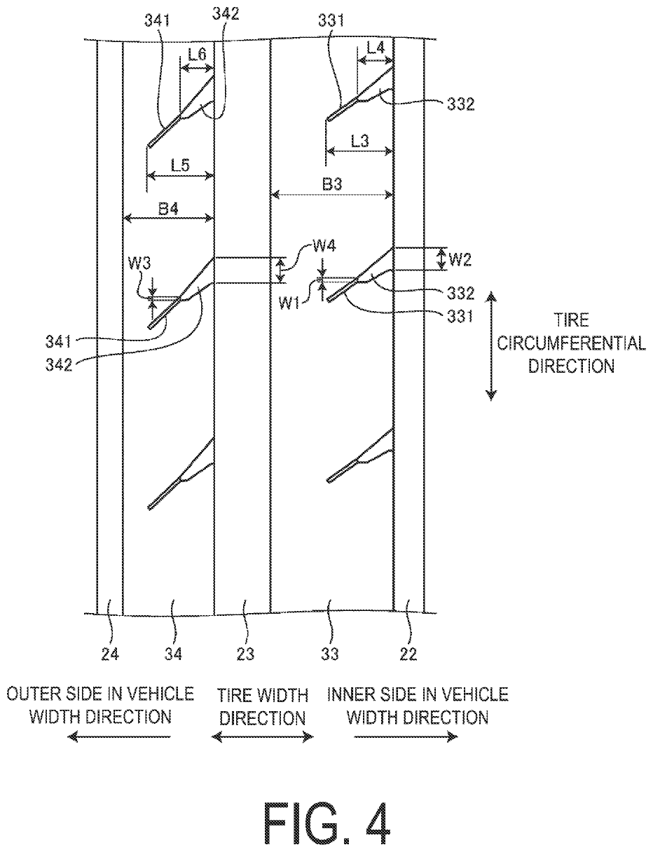

As illustrated in FIG. 2, the tread pattern 15b includes a first main groove 21, a second main groove 22, a third main groove 23, and a fourth main groove 24 as four circumferential main grooves extending along the tire circumferential direction and disposed in the tire width direction from the inner side in the vehicle width direction to the outer side in the vehicle width direction. The tread pattern 15b includes, in the tire width direction from the inner side in the vehicle width direction to the outer side in the vehicle width direction, five land portions of a first land portion 31, a second land portion 32, a third land portion 33, a fourth land portion 34, and a fifth land portion 35 that are defined by four main grooves 21, 22, 23, 24, and extending in a rib shape in the tire circumferential direction. The first land portion 31 and the fifth land portion 35 are also referred to as shoulder land portions on the outer side in the tire width direction, and the second land portion 32, the third land portion 33 and the fourth land portion 34 are also referred to as center land portions on the inner side in the tire width direction. The tread pattern 15b includes a first sipe 311 in the first land portion 31. The tread pattern 15b includes a second sipe 321 in the second land portion 32. The tread pattern 15b includes a third sipe 331 in the third land portion 33. The tread pattern 15b includes a fourth sipe 341 in the fourth land portion 34. The tread pattern 15b includes a narrow groove 351, a fifth sipe 352, and a fifth lug groove 353 in the fifth land portion 35. Further, as illustrated in FIG. 3, the tread pattern 15b includes a second lug groove 322 in the second land portion 32. Further, as illustrated in FIG. 4, the tread pattern 15b includes a third lug groove 332 in the third land portion 33. The tread pattern 15b includes a fourth lug groove 342 in the fourth land portion 34.

Here, “main groove” refers to a groove on which a wear indicator must be provided as specified by the Japan Automobile Tyre Manufacturers Association, Inc. (JATMA) and typically has a groove width of 4.0 mm or more and a groove depth of 6.5 mm or more. “Lug groove” refers to a lateral groove extending along the tire width direction, typically has a groove width of 1.0 mm or more and less than 6.0 mm, a groove depth of 3.0 mm or more and less than 6.5 mm, and opens when the tire comes into contact with the ground to function as a groove. “Narrow groove” refers to a longitudinal groove that extends along the tire circumferential direction, typically has a groove width of 1.0 mm or more and less than 4.0 mm, and a groove depth of 3.0 mm or more and less than 6.5 mm, and opens when the tire comes into contact with the ground to function as a groove. Further, “sipe” refers to a cut formed in the tread contact surface and typically has a sipe width of less than 1.0 mm and a sipe depth of 2.0 mm or more and is closed when the tire comes into contact with the ground.

The groove width is measured as a maximum value of a distance between the left and right groove walls on the tread contact surface when the tire is mounted on a specified rim, inflated to a specified internal pressure, and in an unloaded state. In configurations in which the land portions include notch portions or chamfered portions on the edge portions thereof, the groove width is measured with reference to the intersection points where the tread contact surface and extension lines of the groove walls meet, in a cross-sectional view normal to the groove length direction.

The groove depth is measured as a maximum value of a distance from the tread contact surface to the groove bottom when the tire is mounted on a specified rim, inflated to a specified internal pressure, and in an unloaded state. Additionally, in a configuration in which the grooves include a partially uneven portion or sipe on the groove bottom, the groove depth is measured excluding these portions.

The sipe width is measured as the maximum value of the opening width of the sipe at the road contact surface of the land portion, when the tire is mounted on a specified rim, inflated to the specified internal pressure, and in an unloaded state.

The tire ground contact surface is defined as a contact surface between the tire and a flat plate when the tire is mounted on a specified rim, inflated to the specified internal pressure, placed orthogonal to the flat plate in a static state, and applied with a load corresponding to the specified load.

A specified rim refers to an “Applicable Rim” defined by JATMA, a “Design Rim” defined by the Tire and Rim Association, Inc. (TRA), or a “Measuring Rim” defined by the European Tyre and Rim Technical Organisation (ETRTO). “Specified internal pressure” refers to a “maximum air pressure” specified by JATMA, the maximum value in “TIRE LOAD LIMITS AT VARIOUS COLD INFLATION PRESSURES” specified by TRA, or “INFLATION PRESSURES” specified by ETRTO. A specified load refers to a “maximum load capacity” specified by JATMA, the maximum value in “TIRE LOAD LIMITS AT VARIOUS COLD INFLATION PRESSURES” specified by TRA, or “LOAD CAPACITY” specified by ETRTO. However, in the case of JATMA, for a tire for a passenger vehicle, the specified internal pressure is an air pressure of 180 kPa, and the specified load is 88% of the maximum load capacity.

The tread pattern 15b will be described in detail below.

As illustrated in FIG. 2, the first main groove 21, the second main groove 22, the third main groove 23, and the fourth main groove 24 are formed such that, from the inner side in the vehicle width direction to the outer side in the vehicle width direction, the fourth main groove 24 on the outermost side in the vehicle width direction has the smallest groove width with respect to the other main grooves 21, 22, 23. The main grooves 21, 22, 23 other than the fourth main groove 24 on the outermost side in the vehicle width direction are formed to have the same groove width or a smaller groove width from the inner side in the vehicle width direction to the outer side in the vehicle width direction. The relationship between the groove widths of the main grooves includes an example in which, among the four main grooves, the first main groove 21 has the largest groove width, the second main groove 22 and the third main groove 23 have the same groove width smaller than that of the first main groove 21, and the fourth main groove 24 has the smallest groove width. In the pneumatic tire 1 according to the embodiment, the groove width of the fourth main groove 24 on the outermost side in the vehicle width direction is preferably 75% or less with respect to the groove width of the first main groove 21 on the innermost side in the vehicle width direction in order to obtain the effect of the present disclosure.

As illustrated in FIG. 2, the first sipe 311 in the first land portion 31 is formed such that one end connects to the first main groove 21 and the other end extends to the outer side in the tire width direction. One end of the first sipe 311 is a joining point that does not penetrate the first main groove 21. That is, the first sipe 311 is provided, at a position where the first sipe 311 is connected to the first main groove 21, so as to be displaced in the tire circumferential direction such that the second sipe 321 connected to the first main groove 21 from the second land portion 32 side does not oppose the first sipe 311 on an extension line. A plurality of the first sipes 311 are provided side by side in the tire circumferential direction. The first sipes 311 may have irregular pitches in the tire circumferential direction depending on pitch variation. The first sipe 311 is formed only in the first land portion 31, and other grooves are not formed in the first land portion 31. This is called a sipe base tone.

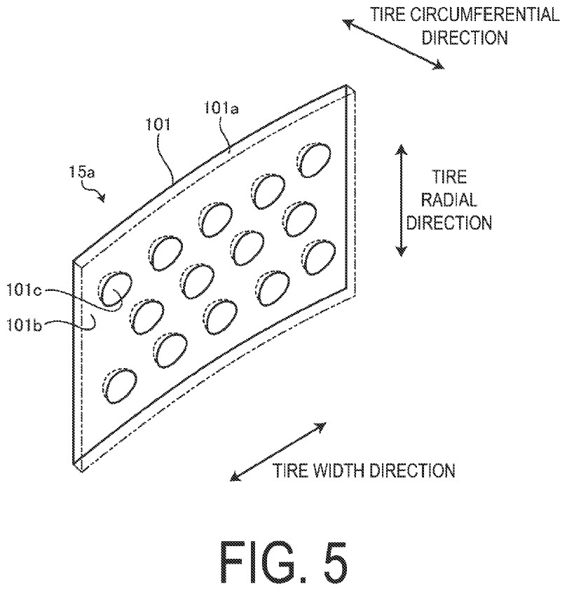

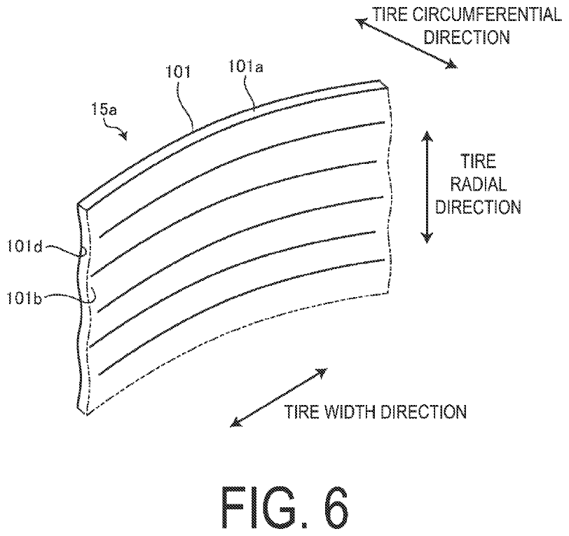

The first sipe 311 is preferably formed in a three-dimensional shape like a sipe 101 illustrated in FIGS. 5 and 6 in order to obtain the effect of the present disclosure. The three-dimensional shape of the sipe 101 illustrated in FIG. 6 is applied to the first sipe 311 of an embodiment.

The sipe 101 illustrated in FIG. 5 is formed such that an opening portion 101a opening to the tread surface 15a is curved. In addition, in the sipe 101 illustrated in FIG. 5, sipe walls 101b along the tire radial direction are formed so as to oppose each other, and a recess/protrusion 101c is formed at least one of the sipe walls 101b. In FIG. 5, the recess/protrusion 101c is formed as a recessed portion (dimple) on one of the sipe walls 101b. In addition, the other of the sipe walls 101b, opposed to the one of the sipe walls 101b in which the recess/protrusion is formed, may not be formed with the recess/protrusion, and may be formed with a protrusion portion entering the dimple. In this way, the sipe 101 illustrated in FIG. 5 is formed in a three-dimensional shape. In addition, the sipe 101 illustrated in FIG. 6 is formed such that the opening portion 101a opening to the tread surface 15a is curved. In addition, in the sipe 101 illustrated in FIG. 6, the sipe walls 101b along the tire radial direction are formed to oppose each other, and each sipe wall 101b is formed in a waveform 101d that meanders (or zigzags) in the tire radial direction. In this way, the sipe 101 illustrated in FIG. 6 is formed in a three-dimensional shape.

As illustrated in FIGS. 2 and 3, the second sipe 321 in the second land portion 32 is formed to extend in the tire width direction. A plurality of the second sipes 321 are provided side by side in the tire circumferential direction. The second sipes 321 may have irregular pitches in the tire circumferential direction depending on pitch variation. The number of the second sipes 321 is twice or more of the number of the third sipes 331 and the number of the fourth sipes 341. As illustrated in FIG. 3, the second lug groove 322 in the second land portion 32 is formed to extend in the tire width direction. A plurality of the second lug grooves 322 are provided side by side in the tire circumferential direction. The second lug grooves 322 may have irregular pitches in the tire circumferential direction depending on pitch variation. In the second land portion 32, only the second sipes 321 and the second lug grooves 322 are formed.

As illustrated in FIG. 3, the second lug groove 322 and the second sipe 321 are formed continuously with each other. Specifically, one end of the second lug groove 322 is connected to the first main groove 21 or the second main groove 22, and the other end of the second lug groove 322 terminates within the second land portion 32. One end of the second sipe 321 is connected to the second main groove 22 or the first main groove 21, and the other end of the second sipe 321 is connected to the other end of the second lug groove 322. That is, in a case where one end of the second lug groove 322 is connected to the first main groove 21, one end of the second sipe 321 is connected to the second main groove 22, and the other end of the second sipe 321 is connected to the other end of the second lug groove 322 to be continuous with each other. On the other hand, in a case where one end of the second lug groove 322 is connected to the second main groove 22, one end of the second sipe 321 is connected to the first main groove 21, and the other end of the second sipe 321 is connected to the other end of the second lug groove 322 to be continuous with each other.

Further, a plurality of pairs of the second lug groove 322 and the second sipe 321 formed continuously with each other are formed side by side in the tire circumferential direction. Pairs of the second lug groove 322 and the second sipe 321 adjacent to each other in the tire circumferential direction are disposed in a staggered manner along the tire circumferential direction. That is, with respect to the pair of the second lug groove 322 and the second sipe 321 in which the second lug groove 322 is connected to the first main groove 21 and the second sipe 321 is connected to the second main groove 22, in another pair adjacent in the tire circumferential direction, the second lug groove 322 is connected to the second main groove 22 and the second sipe 321 is connected to the first main groove 21. In this way, the pairs of the second lug groove 322 and the second sipe 321 formed continuously with each other are disposed in a staggered manner along the tire circumferential direction such that the pairs adjacent in the tire circumferential direction are alternated in the tire width direction.

In addition, in the pairs of the second lug groove 322 and the second sipe 321 adjacent to each other in the tire circumferential direction, the second lug groove 322 is connected to the second sipe 321 with a bias in the tire circumferential direction. Further, in the pairs of the second lug groove 322 and the second sipe 321 adjacent to each other in the tire circumferential direction, the bias of the second lug groove 322 is disposed in a staggered manner along the tire circumferential direction. That is, with respect to the pair of the second lug groove 322 and the second sipe 321 in which the second lug groove 322 is disposed so as to be biased to one side of the second sipe 321 in the tire circumferential direction, in another pair adjacent in the tire circumferential direction, the second lug groove 322 is disposed so as to be biased to the other side of the second sipe 321 in the tire circumferential direction. In this manner, in the pairs of the second lug groove 322 and the second sipe 321 formed continuously with each other, the bias of the second lug groove 322 of the pairs adjacent to each other in the tire circumferential direction is reversed and is disposed in a staggered manner along the tire circumferential direction.

In the pneumatic tire 1 of the embodiment, the second land portion 32 may not include the second lug groove 322 and only the second sipe 321 may be formed in the second land portion 32. In this case, as illustrated in FIG. 2, one end of the second sipe 321 is connected to the first main groove 21 and the other end thereof is connected to the second main groove 22. That is, in the pneumatic tire 1 of the embodiment, when the second lug groove 322 is not included, a tire width direction length L1 of the second sipe 321 is 100% with respect to a width B2 of the second land portion 32 (see FIGS. 2 and 3). In the pneumatic tire 1 of the embodiment, when the second lug groove 322 is included, a tire width direction length L2 of the second lug groove 322 is preferably 45% or less with respect to the width B2 of the second land portion 32 in order to obtain the effect of the present disclosure (see FIG. 3).

As illustrated in FIGS. 2 and 4, the third sipe 331 of the third land portion 33 is formed to extend in the tire width direction. A plurality of the third sipes 331 are provided side by side in the tire circumferential direction. The third sipes 331 may have irregular pitches in the tire circumferential direction depending on pitch variation. The third sipe 331 is preferably formed in a three-dimensional shape like the sipe 101 illustrated in FIGS. 5 and 6 in order to obtain the effect of the present disclosure. The three-dimensional shape of the sipe 101 illustrated in FIG. 5 is applied to the third sipe 331 of the embodiment. As illustrated in FIG. 4, the third lug groove 332 in the third land portion 33 is formed to extend in the tire width direction. A plurality of the third lug grooves 332 are provided side by side in the tire circumferential direction. The third lug grooves 332 may have irregular pitches in the tire circumferential direction depending on pitch variation. In the third land portion 33, only the third sipes 331 and the third lug grooves 332 are formed.

As illustrated in FIG. 4, the third lug groove 332 and the third sipe 331 are formed continuously with each other. Specifically, one end of the third lug groove 332 is connected to the second main groove 22 and the other end of the third lug groove 332 terminates within the third land portion 33. One end of the third sipe 331 is connected to the other end of the third lug groove 332, and the other end of the third sipe 331 terminates within the third land portion 33. That is, in a pair of the third lug groove 332 and the third sipe 331 formed continuously with each other, the third lug groove 332 is connected to the second main groove 22, and the third sipe 331 connected to the third lug groove 332 terminates within the third land portion 33. A plurality of pairs of the third lug groove 332 and the third sipe 331 formed continuously with each other are formed side by side in the tire circumferential direction. In addition, in the pair of the third lug groove 332 and the third sipe 331 formed continuously with each other, the third lug groove 332 is formed so as to have circumferential groove widths W1, W2. The circumferential groove width increases from the circumferential groove width W1 at the other end of the third lug groove 332 to which the third sipe 331 is connected, toward the circumferential groove width W2 at the one end of the third lug groove 332 in which the third lug groove 332 is connected to the second main groove 22. Regarding the circumferential groove widths W1 and W2, W1/W2 is preferably 5% or more and 30% or less in order to obtain the effect of the present disclosure.

In the pneumatic tire 1 of the embodiment, the third land portion 33 may not include the third lug groove 332, and only the third sipe 331 may be formed in the third land portion 33. In this case, the third sipe 331 includes a configuration in which both ends terminate within the third land portion 33 as illustrated in FIG. 2 and a configuration in which one end is connected to the second main groove 22 and the other end terminates within the third land portion 33. In addition, when the third lug groove 332 is included, one end of the third sipe 331 is connected to the other end of the third lug groove 332 and is connected to the second main groove 22 via the third lug groove 332, and the other end terminates within the third land portion 33. In the pneumatic tire 1 of the embodiment, a tire width direction length L3 of the third sipe 331 only or the third sipe 331 and the third lug groove 332 is preferably 70% or less with respect to a width B3 of the third land portion 33 in order to obtain the effect of the present disclosure (see FIG. 4). Additionally, in the pneumatic tire 1 of the embodiment, a tire width direction length L4 of the third lug groove 332 is preferably 40% or less with respect to the width B3 of the third land portion 33 in order to obtain the effect of the present disclosure (see FIG. 4).

As illustrated in FIGS. 2 and 4, the fourth sipe 341 of the fourth land portion 34 is formed to extend in the tire width direction. A plurality of the fourth sipes 341 are provided side by side in the tire circumferential direction. The fourth sipes 341 may have irregular pitches in the tire circumferential direction depending on pitch variation. As illustrated in FIG. 4, the fourth lug groove 342 in the fourth land portion 34 is formed to extend in the tire width direction. A plurality of the fourth lug grooves 342 are provided side by side in the tire circumferential direction. The fourth lug grooves 342 may have irregular pitches in the tire circumferential direction depending on pitch variation. In the fourth land portion 34, only the fourth sipes 341 and the fourth lug grooves 342 are formed.

As illustrated in FIG. 4, the fourth lug groove 342 and the fourth sipe 341 are formed continuously with each other. Specifically, one end of the fourth lug groove 342 is connected to the third main groove 23, and the other end of the fourth lug groove 342 terminates within the fourth land portion 34. One end of the fourth sipe 341 is connected to the other end of the fourth lug groove 342, and the other end of the fourth sipe 341 terminates within the fourth land portion 34. That is, in a pair of the fourth lug groove 342 and the fourth sipe 341 formed continuously with each other, the fourth lug groove 342 is connected to the third main groove 23, and the fourth sipe 341 connected to the fourth lug groove 342 terminates within the fourth land portion 34. A plurality of pairs of the fourth lug groove 342 and the fourth sipe 341 formed continuously with each other are formed side by side in the tire circumferential direction. In addition, in the pair of the fourth lug groove 342 and the fourth sipe 341 formed continuously with each other, the fourth lug groove 342 is formed so as to have circumferential groove widths W3, W4. The circumferential groove width increases from the circumferential groove width W3 at the other end of the fourth lug groove 342 to which the fourth sipe 341 is connected, toward the circumferential groove width W4 at the one end of the fourth lug groove 342 in which the fourth lug groove 342 is connected to the third main groove 23. Regarding the circumferential groove widths W3 and W4, W3/W4 is preferably 5% or more and 30% or less in order to obtain the effect of the present disclosure.

In the pneumatic tire 1 of the embodiment, the fourth land portion 34 may not include the fourth lug groove 342, and only the fourth sipe 341 may be formed in the fourth land portion 34. In this case, as illustrated in FIG. 2, the fourth sipe 341 includes a configuration in which both ends terminate within the fourth land portion 34 and a configuration in which one end is connected to the third main groove 23 and the other end terminates within the fourth land portion 34. In addition, when the fourth lug groove 342 is included, one end of the fourth sipe 341 is connected to the other end of the fourth lug groove 342 and is connected to the third main groove 23 via the fourth lug groove 342, and the other end terminates within the fourth land portion 34. In the pneumatic tire 1 of the embodiment, a tire width direction length L5 of the fourth sipe 341 only or the fourth sipe 341 and the fourth lug groove 342 is preferably 70% or less with respect to a width B4 of the fourth land portion 34 in order to obtain the effect of the present disclosure (see FIG. 4). Additionally, in the pneumatic tire 1 of the embodiment, a tire width direction length L6 of the fourth lug groove 342 is preferably 40% or less with respect to the width B4 of the fourth land portion 34 in order to obtain the effect of the present disclosure (see FIG. 4).

As illustrated in FIG. 2, the narrow groove 351 of the fifth land portion 35 is provided to extend in the tire circumferential direction on the outer side in the tire width direction of the fourth main groove 24. The narrow groove 351 is formed to have a groove width smaller than that of the fourth main groove 24. Specifically, in order to obtain the effect of the present disclosure, the narrow groove 351 is preferably formed to have a groove width of 20% or less with respect to fourth main groove 24. At least one narrow groove 351 is provided in the tire width direction. In the case where a plurality of the narrow grooves 351 are provided, about two narrow grooves are preferably provided in order to suppress generation of noise.

As illustrated in FIG. 2, the fifth sipe 352 in the fifth land portion 35 is formed such that one end is connected to the narrow groove 351 and the other end extends to the outer side in the tire width direction. One end of the fifth sipe 352 is a joining point that does not penetrate the narrow groove 351. That is, the fifth sipe 352 is provided, at a position where the fifth sipe 352 is connected to the narrow groove 351, so as to be displaced in the tire circumferential direction such that, when a sipe or a groove that is connected to the narrow groove 351 is provided on the inner side in the tire width direction, the sipe or the groove does not oppose the fifth sipe 352 on an extension line. A plurality of the fifth sipes 352 are provided side by side in the tire circumferential direction. The fifth sipes 352 may have irregular pitches in the tire circumferential direction depending on pitch variation. Only the fifth sipe 352 is formed on the outer side in the tire width direction of the narrow groove 351 of the fifth land portion 35, and no other groove is formed on the outer side in the tire width direction of the narrow groove 351. This is called a sipe base tone.

The fifth sipe 352 is preferably formed in a three-dimensional shape like the sipe 101 illustrated in FIGS. 5 and 6 in order to obtain the effect of the present disclosure. The three-dimensional shape of the sipe 101 illustrated in FIG. 6 is applied to the fifth sipe 352 of the embodiment.

As illustrated in FIG. 2, one end of the fifth lug groove 353 in the fifth land portion 35 is connected to the fourth main groove 24 and the other end of the fifth lug groove 353 terminates within the fifth land portion 35, and the fifth lug groove 353 is formed extending in the tire width direction. A plurality of the fifth lug grooves 353 are provided side by side in the tire circumferential direction. The fifth lug grooves 353 may have irregular pitches in the tire circumferential direction depending on pitch variation.

As illustrated in FIGS. 2 to 4, in the pneumatic tire 1 of the embodiment, the second sipe 321, the second lug groove 322, the third sipe 331, the third lug groove 332, the fourth sipe 341, and the fourth lug groove 342 provided in the second land portion 32, the third land portion 33, and the fourth land portion 34, which are the center land portions, are preferably provided to be inclined in the same direction with respect to the tire width direction in order to obtain the effect of the present disclosure. Additionally, as illustrated in FIG. 2, in the pneumatic tire 1 of the embodiment, the first sipe 311, the fifth sipe 352, and the fifth lug groove 353 provided in the first land portion 31 and the fifth land portion 35, which are shoulder land portions, have an inclination in the same direction as the second sipe 321, the second lug groove 322, the third sipe 331, the third lug groove 332, the fourth sipe 341, and the fourth lug groove 342.

As described above, in the pneumatic tire 1 of the embodiment, an orientation of the pneumatic tire 1 with respect to the vehicle width direction when the pneumatic tire 1 is mounted on the vehicle is designated, and the tread surface 15a has the tread pattern 15b that is asymmetric in the tire width direction with respect to the tire equatorial plane CL as a boundary. The tread pattern 15b includes four main grooves of the first main groove 21, the second main groove 21, the third main groove 23, and the fourth main groove 24 extending in the tire circumferential direction, provided in the tire width direction from the inner side in the vehicle width direction to the outer side in the vehicle width direction, and formed such that at least a groove width on an outermost side in the vehicle width direction is smaller than a groove width on an innermost side in the vehicle width direction; five land portions of the first land portion 31, the second land portion 32, the third land portion 33, the fourth land portion 34, and the fifth land portion 35 defined by each of the main grooves 21, 22, 23, 24, extending in a rib shape in the tire circumferential direction, and provided in the tire width direction from the inner side in the vehicle width direction to the outer side in the vehicle width direction; at least one narrow groove 351 extending in the tire circumferential direction and provided in the tire width direction in the fifth land portion 35, the narrow groove 351 having a groove width smaller than a groove width of the fourth main groove 24; the plurality of first sipes 311 provided in the tire circumferential direction in the first land portion 31, the first sipes 311 each having one end that is connected to but does not extend over the first main groove 21 and the other end extending to the outer side in the tire width direction, the first sipes 311 being provided only in the first land portion 31; the plurality of second sipes 321 extending in the tire width direction and provided in the tire circumferential direction in the second land portion 32; the plurality of third sipes 331 extending in the tire width direction and provided in the tire circumferential direction in the third land portion 33; the plurality of fourth sipes 341 extending in the tire width direction and provided in the tire circumferential direction in the fourth land portion 34; the plurality of fifth sipes 352 provided in the tire circumferential direction in the fifth land portion 35, the fifth sipes 352 each having one end that is connected to but does not extend over the narrow groove 351 and the other end extending to the outer side in the tire width direction, the fifth sipes 352 being provided only on the outer side in the tire width direction of the narrow groove 351; and the plurality of fifth lug grooves 353 provided in the tire circumferential direction in the fifth land portion 35, the fifth lug grooves 353 each having one end connected to the fourth main groove 24 and the other end that extends to the outer side in the tire width direction, is not connected to the narrow groove 351, and terminates. Furthermore, the number of the second sipes 321 is twice or more of the number of the third sipes 331 and the number of the fourth sipes 341. The sipes 321, 331, 341 and the grooves (322, 332, 342) provided in the second land portion 32, the third land portion 33, and the fourth land portion 34 are provided to be inclined in the same direction with respect to the tire width direction. The first sipes 311, the fifth sipes 352, and the fifth lug grooves 353 have an inclination in the same direction as the sipes 321, 331, 341 and the grooves (322, 332, 342) provided in the second land portion 32, the third land portion 33, and the fourth land portion 34.

According to the pneumatic tire 1, in the above-described configuration, drainage performance is ensured and high wet grip performance is obtained on the inner side in the vehicle width direction, and pitch noise is reduced and noise performance is obtained on the outer side in the vehicle width direction. Specifically, according to the pneumatic tire 1, the groove width of the first main groove 21 is large on the inner side in the vehicle width direction, and the groove width of the fourth main groove 24 is small on the outer side in the vehicle width direction, thereby providing drainage performance and reduced pitch noise in a compatible manner. The number of the second sipes 321 in the second land portion 32 is greater than the number of third sipes 331 in the third land portion 33 and the number of fourth sipes 341 in the fourth land portion 34, thereby providing drainage performance and reduced pitch noise in a compatible manner. Since the narrow groove 351 is formed in the fifth land portion 35 on the outer side in the vehicle width direction, the groove volume is compensated for against the reduction of the groove width of the fourth main groove 24, thereby compensating for the drainage performance on the outer side in the vehicle width direction. The fifth lug groove 353 is not connected to the narrow groove 351 to reduce pitch noise. The first sipe 311 and the fifth sipe 352 are configured not to penetrate the grooves to reduce pitch noise, and the circumferential positions thereof are displaced from other sipes to reduce pitch noise. The directions of inclination angles of the sipes and the lug grooves are aligned, thereby improving drainage performance.

Additionally, the pneumatic tire 1 of the embodiment further includes the second lug groove 322 in the second land portion 32 including one end connected to the first main groove 21 or the second main groove 22 and the other end terminating within the second land portion 32. The second sipe 321 includes one end connected to the second main groove 22 or the first main groove 21 and the other end connected to the other end of the second lug groove 322.

According to the pneumatic tire 1, wet grip performance and noise performance can be provided in a compatible manner by ensuring the groove volume on the inner side in the vehicle width direction in the minimum necessary range in the second land portion 32 close to the inner side in the vehicle width direction.

Additionally, in the pneumatic tire 1 of the embodiment, the second lug groove 322 and the second sipe 321 that are continuous with each other are arranged in a staggered manner along the tire circumferential direction.

According to the pneumatic tire 1, in the asymmetric tread pattern 15b, a difference in drainage properties can be reduced in a case where the rotation direction is reversed due to a tire low tension, and wet grip performance can be improved.

Additionally, in the pneumatic tire 1 of the embodiment, the second lug groove 322 is connected to the second sipe 321 with a bias in the tire circumferential direction, and the bias is disposed in a staggered manner along the tire circumferential direction.

According to the pneumatic tire 1, pitch noise can be reduced and noise performance can be improved by diversifying the interval in the tire circumferential direction.

Further, in the pneumatic tire 1 of the embodiment, the third sipe 331 includes one end connected to the second main groove 22, and the other end terminating within the third land portion 33, and the fourth sipe 341 includes one end connected to the third main groove 23, and the other end terminating within the fourth land portion 34.

According to the pneumatic tire 1, noise performance can be improved by preventing pumping noise from leaking to the outside.

Further, the pneumatic tire 1 of the embodiment further includes, in the third land portion 33, the third lug groove 332 including one end connected to the second main groove 22 and the other end terminating within the third land portion 33; and in the fourth land portion 34, the fourth lug groove 342 including one end connected to the third main groove 23 and the other end terminating within the fourth land portion 34. The third sipe 331 includes one end connected to the other end of the third lug groove 332 and connected to the second main groove 22 via the third lug groove 332, and the fourth sipe 341 includes one end connected to the other end of the fourth lug groove 342 and connected to the third main groove 23 via the fourth lug groove 342.

According to the pneumatic tire 1, wet grip performance and noise performance can be provided in a compatible manner by ensuring the groove volume in the minimum necessary range.

Further, in the pneumatic tire 1 of the embodiment, the third lug groove 332 is formed such that a circumferential groove width thereof increases from the other end to the one end, and the fourth lug groove 342 is formed such that a circumferential groove width thereof increases from the other end to the one end.

According to the pneumatic tire 1, wet grip performance and noise performance can be provided in a compatible manner by further ensuring the groove volume in the minimum necessary range.

Further, in the pneumatic tire 1 of the embodiment, the third sipe 331 has a three-dimensional shape.

According to the pneumatic tire 1, suppression of uneven wear and securement of drainage properties can be provided in a compatible manner in the third land portion 33 on the inner side in the tire width direction by securing rigidity.

Further, in the pneumatic tire 1 of the embodiment, the first sipe 311 and the fifth sipe 352 have a three-dimensional shape.

According to the pneumatic tire 1, falling of the first land portion 31 and the fifth land portion 35 on the outer side in the tire width direction is prevented, heel and toe wear between the sipes in the tire circumferential direction is prevented, pitch noise is reduced, and therefore noise performance can be improved.

In the present embodiment, as described above, a pneumatic tire is described as an example of a tire. However, no such limitation is intended, and the configurations described in the present embodiment can also be applied to other tires in a discretionary manner within the scope of obviousness to one skilled in the art. Examples of other tires include an airless tire.

### EXAMPLES

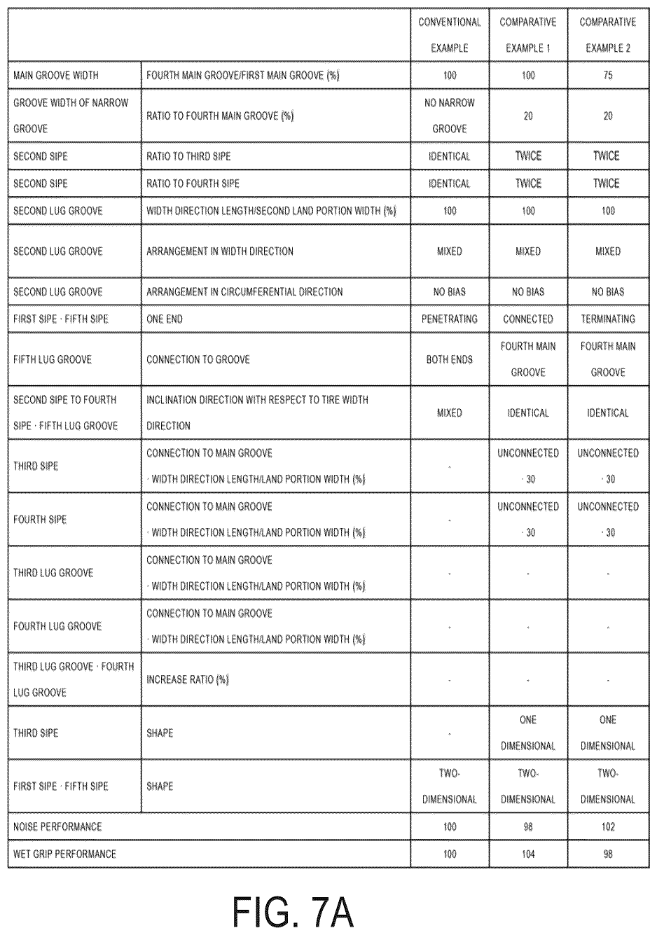

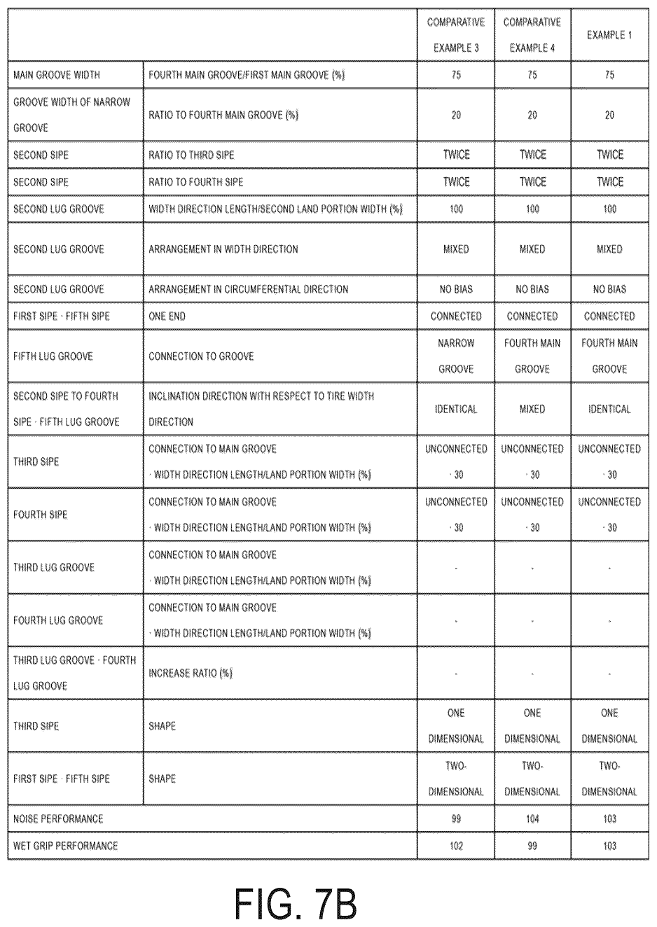

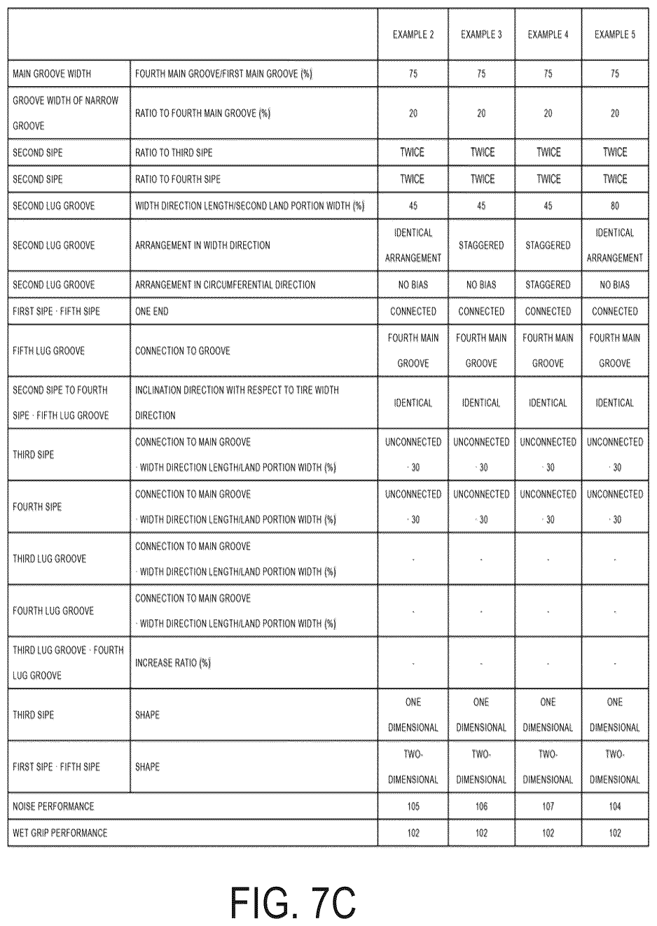

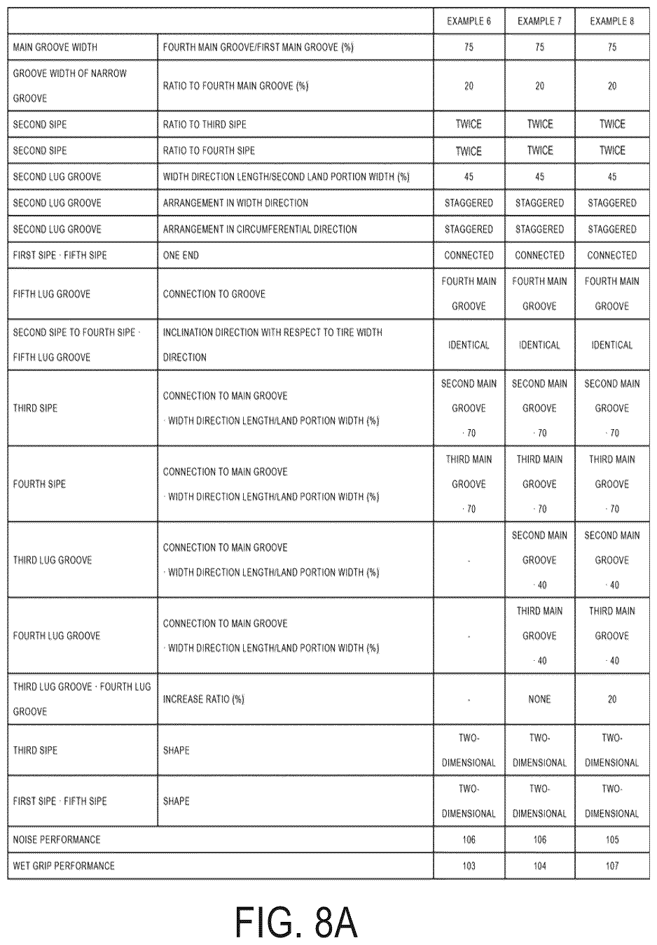

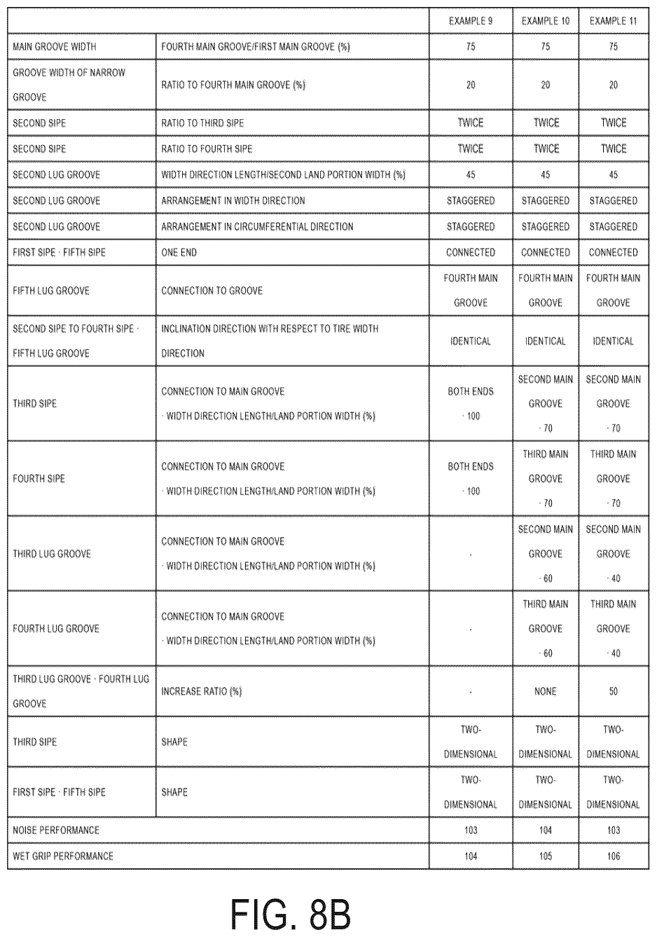

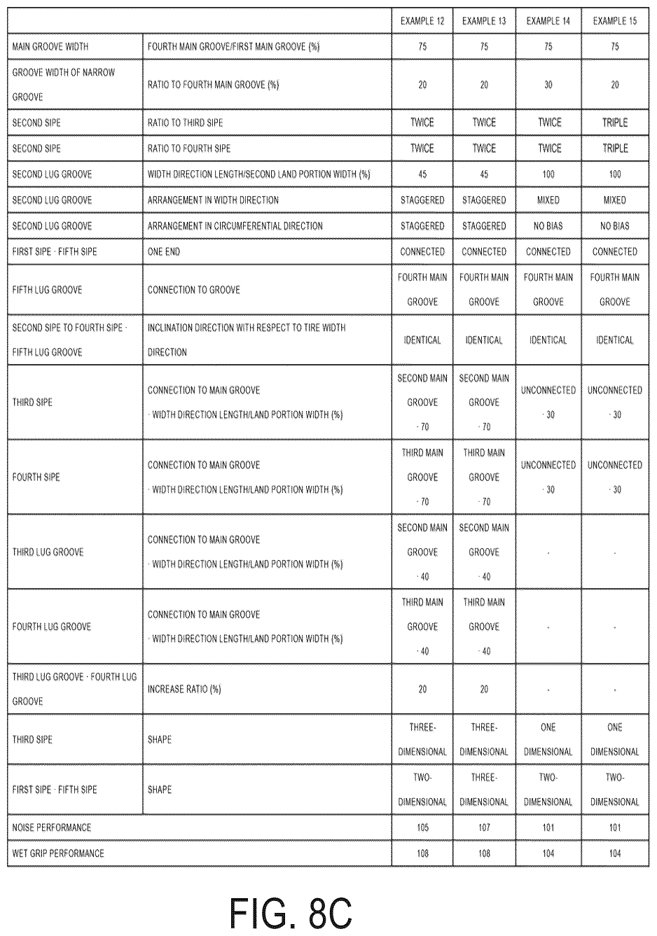

FIGS. 7A-7C and 8A-8C are tables showing the results of performance tests of pneumatic tires according to embodiments. Hereinafter, evaluation tests of performance conducted on pneumatic tires of a conventional example, pneumatic tires of comparative examples, and pneumatic tires of examples according to embodiments will be described. For performance evaluation tests, tests on noise performance and wet grip performance were performed.

In the evaluation test of noise performance, pneumatic tires with a tire size of 235/50R18 97W were mounted on standard rims with a rim size of 18×7.5 J defined by JATMA, and attached to a 2WD minivan as a test vehicle. Air pressure was applied at 230 kPa on the front and 240 kPa on the rear. Then, in the evaluation test, the test vehicle was driven by a test driver to travel on a test course, and noise energy at the driver seat was measured and indexed. The evaluation was conducted by using index values with the conventional example being assigned as the reference (100). Larger reciprocals of the values indicate more excellent noise performance.

In the evaluation test of wet grip performance, pneumatic tires with a tire size of 235/50R18 97W were mounted on standard rims with a rim size of 18×7.5 J defined by JATMA, and attached to a 2WD minivan as a test vehicle. Air pressure was applied at 220 kPa on both the front and the rear. Then, in the evaluation test, the test vehicle was driven by a test driver to travel on a test course with an R711 reference road surface, and the wet grip performance was measured based on the μ-s characteristics and indexed. The evaluation was conducted by using index values with the conventional example being assigned as the reference (100). Larger values indicate more excellent noise performance.

In the pneumatic tire of the conventional example, all of the four main grooves have the same groove width, no narrow groove is provided, the ratio of the second sipe to the third sipe and that to the fourth sipe is the same, the first sipe is provided so as to penetrate the groove, and the fifth lug groove is connected to and is continuous with the fifth sipe.

In the pneumatic tire of the Example 1, the first main groove has the greatest groove width among the four main grooves, the second main groove and the third main groove have the same groove width smaller than the groove width of the first main groove, and the fourth main groove has the smallest groove width, a narrow groove having a groove width smaller than the groove width of the fourth main groove is provided, the ratio of the second sipe to the third sipe and that to the fourth sipe is twice, the first sipe and the fifth sipe is provided not to penetrate but to be connected to the groove, and the fifth lug groove is provided to be connected to only the fourth main groove. In addition, other characteristics of the pneumatic tires of the Examples 2 to 15 are specified.

The pneumatic tires of the Comparative Examples 1 to 4 differ from the pneumatic tire of the Example 1 in some of the specifications.

As can be seen from the test results, in the pneumatic tires of the present examples, noise performance and wet grip performance are improved with respect to those of the conventional examples.

The present disclosure includes the following technologies.

### Technology 1

A tire including, in a tread surface, a tread pattern that is asymmetric with respect to a tire equatorial plane as a boundary and has an orientation designated with respect to a vehicle width direction when mounted on a vehicle, the tread pattern including:
four main grooves of a first main groove, a second main groove, a third main groove, and a fourth main groove extending in a tire circumferential direction, provided in a tire width direction from an inner side in the vehicle width direction to an outer side in the vehicle width direction, and formed such that at least a groove width on an outermost side in the vehicle width direction is smaller than a groove width on an innermost side in the vehicle width direction;
five land portions of a first land portion, a second land portion, a third land portion, a fourth land portion, and a fifth land portion defined by each of the main grooves, extending in a rib shape in the tire circumferential direction, and provided in the tire width direction from the inner side in the vehicle width direction to the outer side in the vehicle width direction;
at least one narrow groove extending in the tire circumferential direction and provided in the tire width direction in the fifth land portion, the narrow groove having a groove width smaller than a groove width of the fourth main groove;
a plurality of first sipes provided in the tire circumferential direction in the first land portion, the first sipes each having one end that is connected to but does not extend over the first main groove and the other end extending to the outer side in the tire width direction, the first sipes being provided only in the first land portion;
a plurality of second sipes extending in the tire width direction and provided in the tire circumferential direction in the second land portion;
a plurality of third sipes extending in the tire width direction and provided in the tire circumferential direction in the third land portion;
a plurality of fourth sipes extending in the tire width direction and provided in the tire circumferential direction in the fourth land portion;
a plurality of fifth sipes provided in the tire circumferential direction in the fifth land portion, the fifth sipes each having one end that is connected to but does not extend over the narrow groove and the other end extending to the outer side in the tire width direction, the fifth sipes being provided only on an outer side in the tire width direction of the narrow groove; and
a plurality of fifth lug grooves provided in the tire circumferential direction in the fifth land portion, the fifth lug grooves each having one end connected to the fourth main groove and the other end that extends to the outer side in the tire width direction, is not connected to the narrow groove, and terminates;
the number of the second sipes being twice or more of the number of the third sipes and the number of the fourth sipes,
the sipes and grooves provided in the second land portion, the third land portion, and the fourth land portion being provided to be inclined in the same direction with respect to the tire width direction, and
the first sipes, the fifth sipes, and the fifth lug grooves having an inclination in the same direction as the sipes and the grooves provided in the second land portion, the third land portion, and the fourth land portion.

### Technology 2

The tire according to the Technology 1, further including a second lug groove in the second land portion, the second lug groove including one end connected to the first main groove or the second main groove and the other end terminating within the second land portion, in which
a second sipe among the second sipes includes one end connected to the second main groove or the first main groove and the other end connected to the other end of the second lug groove.

### Technology 3

The tire according to the Technology 2, in which the second lug groove and the second sipe connected to each other are arranged in a staggered manner along the tire circumferential direction.

### Technology 4

The tire according to the Technology 3, in which the second lug groove is connected to the second sipe with a bias in the tire circumferential direction, and the bias is disposed in a staggered manner along the tire circumferential direction.

### Technology 5

The tire according to any one of the Technologies 1 to 4, in which
the third sipes each have one end connected to the second main groove and the other end terminating within the third land portion, and
the fourth sipes each have one end connected to the third main groove and the other end terminating within the fourth land portion.

### Technology 6

The tire according to the Technology 5, further including:
in the third land portion, a third lug groove including one end connected to the second main groove and the other end terminating within the third land portion; and
in the fourth land portion, a fourth lug groove including one end connected to the third main groove and the other end terminating within the fourth land portion; in which
a third sipe among the third sipes includes one end connected to the other end of the third lug groove and connected to the second main groove via the third lug groove, and
a fourth sipe among the fourth sipes includes one end connected to the other end of the fourth lug groove and connected to the third main groove via the fourth lug groove.

### Technology 7

The tire according to the Technology 6, in which
the third lug groove is formed such that a circumferential groove width of the third lug groove increases from the other end to the one end, and
the fourth lug groove is formed such that a circumferential groove width of the fourth lug groove increases from the other end to the one end.

### Technology 8

The tire according to any one of the Technologies 1 to 7, in which the third sipes have a three-dimensional shape.

### Technology 9

The tire according to any one of the Technologies 1 to 8, in which the first sipes and the fifth sipes have a three-dimensional shape.

1. A tire comprising, in a tread surface, a tread pattern that is asymmetric with respect to a tire equatorial plane as a boundary and has an orientation designated with respect to a vehicle width direction when mounted on a vehicle, the tread pattern comprising:
four main grooves of a first main groove, a second main groove, a third main groove, and a fourth main groove extending in a tire circumferential direction, provided in a tire width direction from an inner side in the vehicle width direction to an outer side in the vehicle width direction, and formed such that at least a groove width on an outermost side in the vehicle width direction is smaller than a groove width on an innermost side in the vehicle width direction;
five land portions of a first land portion, a second land portion, a third land portion, a fourth land portion, and a fifth land portion defined by each of the main grooves, extending in a rib shape in the tire circumferential direction, and provided in the tire width direction from the inner side in the vehicle width direction to the outer side in the vehicle width direction;
at least one narrow groove extending in the tire circumferential direction and provided in the tire width direction in the fifth land portion, the narrow groove having a groove width smaller than a groove width of the fourth main groove;
a plurality of first sipes provided in the tire circumferential direction in the first land portion, the first sipes each having one end that is connected to but does not extend over the first main groove and the other end extending to the outer side in the tire width direction, the first sipes being provided only in the first land portion;
a plurality of second sipes extending in the tire width direction and provided in the tire circumferential direction in the second land portion;
a plurality of third sipes extending in the tire width direction and provided in the tire circumferential direction in the third land portion;
a plurality of fourth sipes extending in the tire width direction and provided in the tire circumferential direction in the fourth land portion;
a plurality of fifth sipes provided in the tire circumferential direction in the fifth land portion, the fifth sipes each having one end that is connected to but does not extend over the narrow groove and the other end extending to the outer side in the tire width direction, the fifth sipes being provided only on an outer side in the tire width direction of the narrow groove; and
a plurality of fifth lug grooves provided in the tire circumferential direction in the fifth land portion, the fifth lug grooves each having one end connected to the fourth main groove and the other end that extends to the outer side in the tire width direction, is not connected to the narrow groove, and terminates;
a number of the second sipes being twice or more of a number of the third sipes and the number of the fourth sipes,
the second sipes, the third sipes, and the fourth sipes respectively provided in the second land portion, the third land portion, and the fourth land portion being provided to be inclined in the same direction with respect to the tire width direction, and
the first sipes, the fifth sipes, and the fifth lug grooves having an inclination in the same direction as the second sipes, the third sipes, and the fourth sipes respectively provided in the second land portion, the third land portion, and the fourth land portion.

2. The tire according to claim 1, further comprising a second lug groove in the second land portion, the second lug groove comprising one end connected to the first main groove or the second main groove and the other end terminating within the second land portion, wherein
a second sipe among the second sipes comprises one end connected to the second main groove or the first main groove and the other end connected to the other end of the second lug groove, and
the second lug groove is inclined in the same direction with respect to fire width direction as the second sipes.

3. The tire according to claim 2, wherein the second lug groove and the second sipe connected to each other are arranged in a staggered manner along the tire circumferential direction.

4. The tire according to claim 3, wherein the second lug groove is connected to the second sipe with a bias in the tire circumferential direction, and the bias is disposed in a staggered manner along the tire circumferential direction.

5. The tire according to claim 1, wherein
the third sipes each have one end connected to the second main groove and the other end terminating within the third land portion, and
the fourth sipes each have one end connected to the third main groove and the other end terminating within the fourth land portion.

6. The tire according to claim 5, further comprising:
in the third land portion, a third lug groove comprising one end connected to the second main groove and the other end terminating within the third land portion; and
in the fourth land portion, a fourth lug groove comprising one end connected to the third main groove and the other end terminating within the fourth land portion; wherein
a third sipe among the third sipes comprises one end connected to the other end of the third lug groove and connected to the second main groove via the third lug groove, and
a fourth sipe among the fourth sipes comprises one end connected to the other end of the fourth lug groove and connected to the third main groove via the fourth lug groove.
the third lug groove is inclined in the same direction with respect to the tire width direction as the third sipes, and
the fourth lug groove is inclined in the same direction with respect to the tire width direction as the fourth sipes.

7. The tire according to claim 6, wherein
the third lug groove is formed such that a circumferential groove width of the third lug groove increases from the other end to the one end, and
the fourth lug groove is formed such that a circumferential groove width of the fourth lug groove increases from the other end to the one end.

8. The tire according to claim 1, wherein the third sipes have a three-dimensional shape.

9. The tire according to claim 1, wherein the first sipes and the fifth sipes have a three-dimensional shape.
